(19) United States
(12) Patent Application Publication
(10) Pub. No.: US 2009/0321523 A1
(43) Pub. Date: Dec. 31, 2009

(54) IMAGE CAPTURE DEVICE, ILLUMINATOR AND LIGHT COLLIMATING OPTICAL ELEMENT ARRANGEMENT FOR IMAGING SYSTEM

(75) Inventors: Russ Calvarese, Stony Brook, NY (US); Tim Austin, Stony Brook, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/147,110

(22) Filed: Jun. 26, 2008

(51) Int. Cl. G06K 7/10

(52) U.S. Cl. 235/462.42; 235/462.01

(57) ABSTRACT

Collimating the light used to provide illumination for image capture can also provide an aiming mechanism for an imaging system. In some embodiments, an imager component that captures at least one image, and an illumination and aiming component provides users with a mechanism for intuitive aiming of the imaging system and illumination to facilitate image capture by the imager component.

### BACKGROUND

Imaging technology, particularly digital imaging technology, has experienced significant growth over the past several years. This growth has lead to imaging systems of increased sophistication and complexity. Imaging systems now contain considerable computing power, as well as improved imaging resolutions compared to a few years ago. Additionally, the size of the packaging for imaging systems is continually decreasing. However, the increasing sophistication and decreasing size of current imaging systems has also led to the use of intricate and expensive components.

Imaging systems, such as bar code readers, often contain separate components for image capture, device aiming, and illumination. The aiming components typically are comprised of expensive and complicated display screens, such as liquid crystal diode (LCD) screens. The use of display screens not only drives up the manufacturing cost of these imaging systems, but also increases their overall size and power consumption.

While the sophistication of imaging systems is increasing, and the packaging size is decreasing, the price and difficulty to manufacture these imaging systems continues to increase as well. In addition, as electronics become more mobile there is a demand to drive down power consumption. Therefore, it would be desirable to have a system that combined or made obsolete the functionality of one or more components of an imaging system, while decreasing overall cost, power consumption, and complexity.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with imaging systems. In accordance with some aspects presented herein, provided is a system that has an imager component that captures at least one image, and an illumination and aiming component that provides users with a mechanism for intuitive aiming of the imaging system and illumination to facilitate image capture by the imager component.

According to another aspect, an imaging system is disclosed having an imager component that captures at least one image, and an illumination and aiming component that includes a source and a collimating optical element. The source emits visible light, and the collimating optical element focuses the light on a region, wherein the focused light provides a mechanism for intuitive aiming of the imaging system and illumination to facilitate image capture by the imager component.

Yet another aspect of an imaging system is disclosed, wherein the system contains an imager that captures at least one image, and analyzes the captured images to at least one of: identify, locate, or decode at least one of: a bar code, or a data matrix, and an illumination and aiming component that includes a source and optical collimating element. The source is at least one light emitting diode (L.E.D) that emits visible light, and the optical collimating element is a is a refractive lens containing at least one aperture, wherein the lens collimates the visible light, and the aperture allows light to traverse the lens uninterrupted.

According to another aspect, an imaging system is disclosed having means for emitting visible light, and means for focusing the visible light on a region. The focused visible light provides illumination of at least one subject, and a means for aiming the imaging system by observing the focused visible light. In addition, the system includes means for imaging the subjects, and means for analyzing the subjects to at least one of: identify, locate, or decode data contained in the imaged subject.

Yet another aspect of an imaging apparatus is disclosed, including a source that emits visible light, a refractive lens containing an aperture located a first distance from the source that creates an illuminated region. The refractive lens collimates the light emitted from the source, and the aperture allows the light to traverse at least a portion of the lens uninterrupted, and an imager that captures at least one image, the images are located within the illuminated region.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a block diagram of an imaging system in accordance with an aspect of the present invention.

FIG. 2 illustrates a block diagram of an imaging system in accordance with an aspect of the present invention.

FIG. 3 illustrates an exemplary application of an imaging system in accordance with an aspect of the present invention.

FIG. 4 illustrates an exemplary application of an imaging system in accordance with an aspect of the present invention.

FIG. 5 illustrates an exemplary application of an imaging system in accordance with an aspect of the present invention.

FIG. 6 illustrates an exemplary application of an imaging system in accordance with an aspect of the present invention.

FIG. 7 illustrates a system that employs an artificial intelligence component that facilitates automating one or more features in accordance with the subject invention.

FIG. 8 illustrates a block diagram of a computer operable to execute the disclosed embodiments.

FIG. 9 illustrates an exemplary device operative to execute the one or more embodiments disclosed herein.

FIG. 10 is a schematic block diagram illustrating a suitable operating environment in accordance with an aspect of the subject invention.

### DETAILED DESCRIPTION

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used.

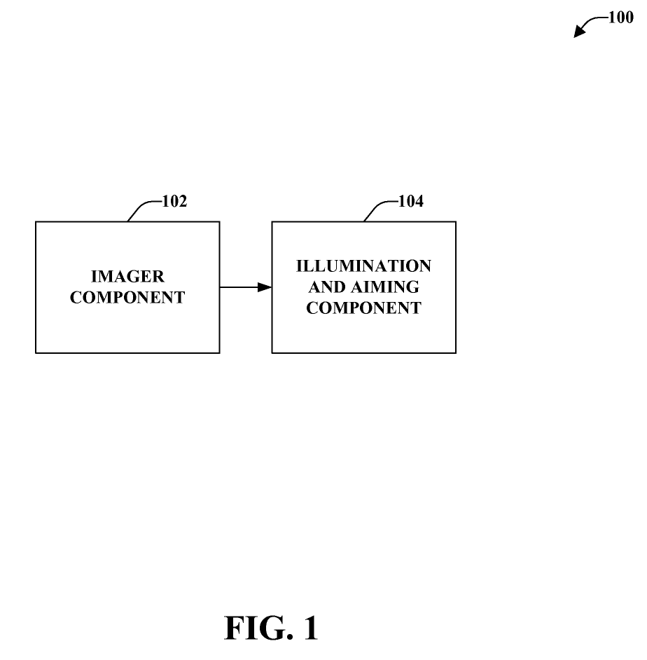

Referring initially to FIG. 1, illustrated is an exemplary block diagram of an imaging system 100. The system 100 includes an imager component 102, and an illumination and aiming component 104. The imager component 102 captures images via processes and systems that are well known in the art. The imager component 102 can capture images (e.g. digital, analog, etc.), and store the image via any suitable means, such as a computer readable storage medium. In addition, the imager component 102 can analyze the captured images. For instance, the imager component 102 can analyze the captured image to locate an instance of a particular type of data, and subsequently examine the data.

The illumination and aiming component 104 projects electromagnetic energy onto a region, the electromagnetic energy can be in the visible light spectrum. The light provides the imager component 102 with the illumination necessary or desired to capture an image accurately. Simultaneously, the illumination and aiming component 104 provides users with a mechanism for aiming the imaging system 100. For instance, a user may want to capture a specific instance of data contained in an area, the region of the area that is illuminated by the illumination and aiming component 104 provides users with an efficient and simple means of identifying the region that will be captured and/or analyzed by the imager component 102.

The imaging system 100 can be implemented in a mobile device (e.g. hand-held device, wireless device, cell phone, smart phone, portable computer, etc.). Additionally or alternatively, the imaging system 100 can be realized as part of an automated system (e.g. desktop computer, industrial equipment, office equipment, retail equipment, etc.).

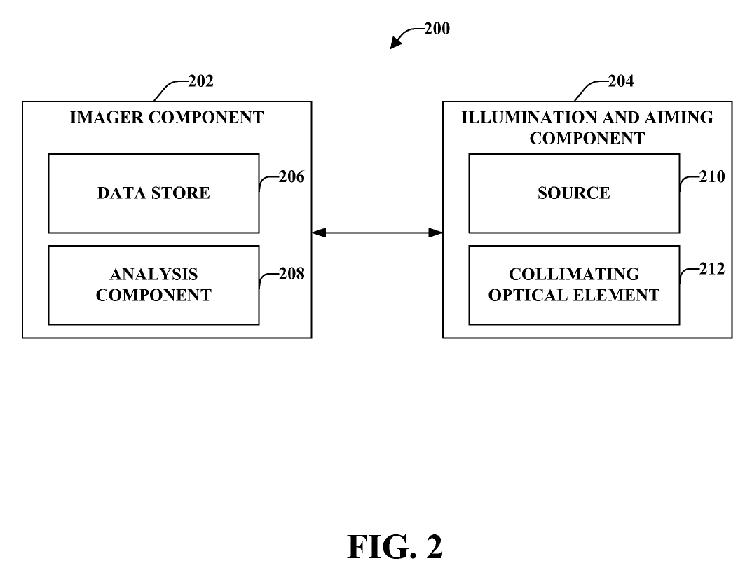

Referring to FIG. 2, illustrated is an exemplary block diagram of an imaging system 200. The system 200 includes an imager component 202, and an illumination and aiming component 204. The imager component 202 captures images using means that are well known in the art. The imager component 202 can capture an image, and store the image via any suitable means, such as a data store 206 (e.g. computer readable storage medium). In addition, the imager component 202 includes an analysis component 208. The analysis component 208 locates instances of predefined data types in the captured images. The data types can include but are not limited to bar codes, data matrices, etc. Additionally, the analysis component 208 can analyze or decode the data types. For instance, the analysis component 208 can locate a bar code in a captured image, and decode the bar code to obtain data, such as retail data, identity data, manufacturer data, location data, shipping data, and so forth. Subsequently, the data can be displayed to the user, or the data can be communicated to another system.

The illumination and aiming component 204 cast electromagnetic energy onto a region, wherein the electromagnetic energy is visible light. The light provides the imager component 202 with a desired amount of illumination for image capture. Simultaneously, the illumination and aiming component 204 provides users with a mechanism for aiming the imaging system 200. The illumination and aiming component 204 includes a source 210, and a collimating optical element 212. The source can include any means of projecting visible light, including but not limited to light emitting diodes (L.E.D), incandescent light bulbs, halogen light bulbs, fluorescent light bulbs, mercury bulbs, metal halide bulbs, low-pressure sodium lamps, laser, etc. The collimating optical element 212 focuses the light on the region. Typically, unobstructed light waves propagate along a radial path, whereas the collimating optical element 212 causes the light from the source 210 to converge on a predetermined region. For instance, the collimating optical element 212 can be comprised of one or more refractive lens, one or more reflectors, one or more interference elements, as well as a combination of the foregoing. The region of convergence is determined by the properties of the collimating optical element 212, such as distance from the source 210, size, design, angle, etc.

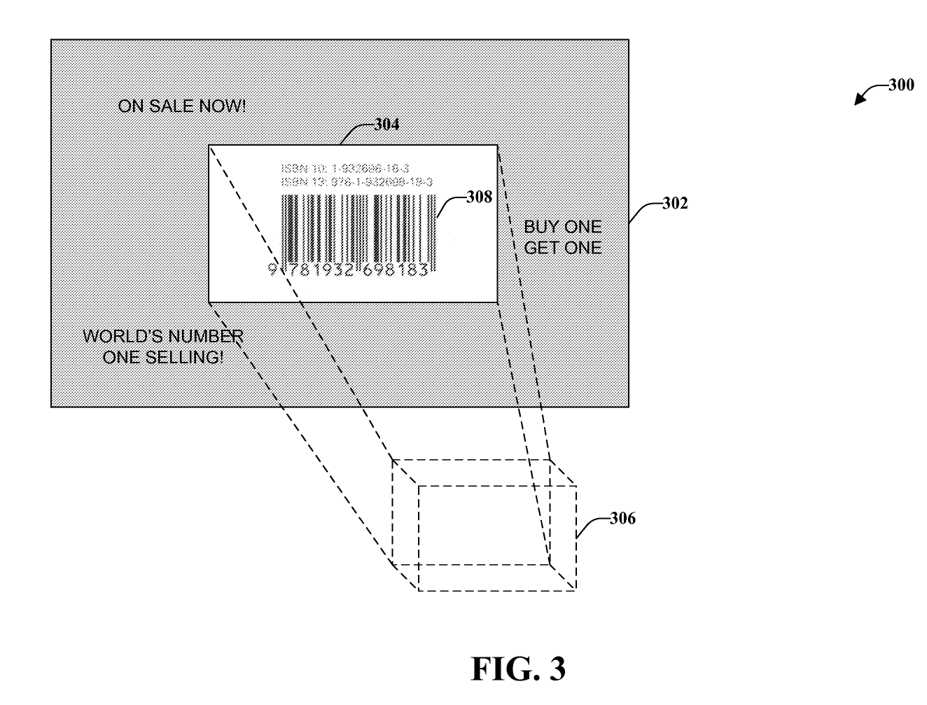

Referring to FIG. 3, an exemplary application 300 of an imaging system is shown in accordance with an aspect of the present invention. The application 300 includes an area 302, an illuminated region 304, and an imager 306. The area 302 includes a plurality of data types, including a bar code 308. A user may desire to analyze, capture, and/or store an image of the bar code 308. An image of the bar code 308 can be captured using the imager 306 (e.g. imaging system). The imager 306 projects illumination onto the area 302 generating the illuminated region 304. The illumination provides light in the illuminated region 304 which assist in the capture of an image by the imager 306 (discussed supra), and provides users with a mode of aiming the imager 306. As illustrated, users can observe the illuminated region 304, and infer the portion of the area 302 that will be captured by the imager 306. It is to be appreciated that the illuminated region can be any shape or size, and is determined by the properties of the imager 306 and a collimating optical element (as noted supra).

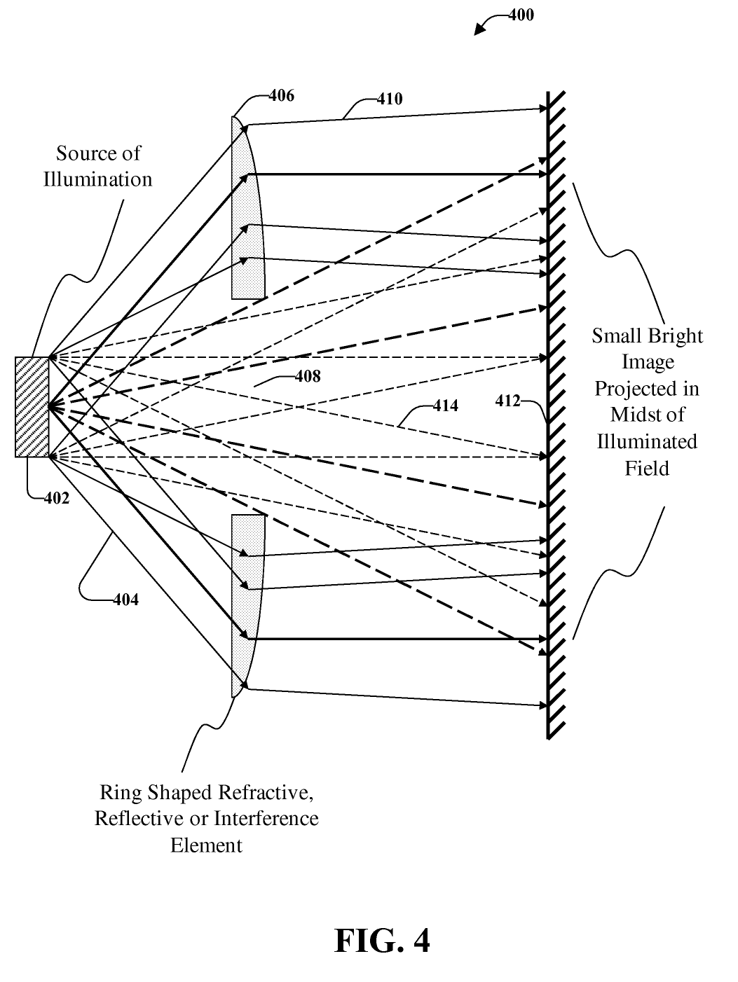

Referring to FIG. 4, a side view of a collimating optical element illustrating light paths forming an aiming image in the midst of an illuminated field is shown. A source 402 emits light (as previously discussed), and initially the light waves 404 propagate along a partial radial path. A ring shape refractive lens 406 having an aperture 408 is located a predetermined distance from the source 402. The lens 406 redirects a first set of the light waves 410 onto an image 412, wherein without interruption the first set of light waves 410 would have been focused outside of the desired illuminated area (e.g. the image 410). The aperture 408 allows a second set of the light waves 414 to traverse the lens 406 uninterrupted. The second set of the light waves 414 propagate along their original path onto the desired illuminated area (e.g. the image 410). Consequently, a substantial portion of the light emitted from the source 402 is directed at the image 412. The increased concentration of light waves 404 generates a brighter illumination compared to conventional illuminations methods. Brighter illumination allows for more intuitive aiming of the imager, and provides increased light for image capture.

It can be seen that adjusting the size of the aperture 408, and design of the lens 406 (e.g. size, curvature, angle, refractivity, translucence, distance from source, etc.) will alter the size of the illuminated region and the amount of illumination projected into the region. It is to be appreciated that adjustment of the collimating optical element (e.g. lens 406 and/or aperture 408) can be static or dynamic. For instance, the collimating optical element could be adjusted via an automated control, wherein the automated control adjusts characteristics of the collimating optical element (e.g. angle, aperture size, etc.) to achieve a desired illuminated region and/or illumination intensity.

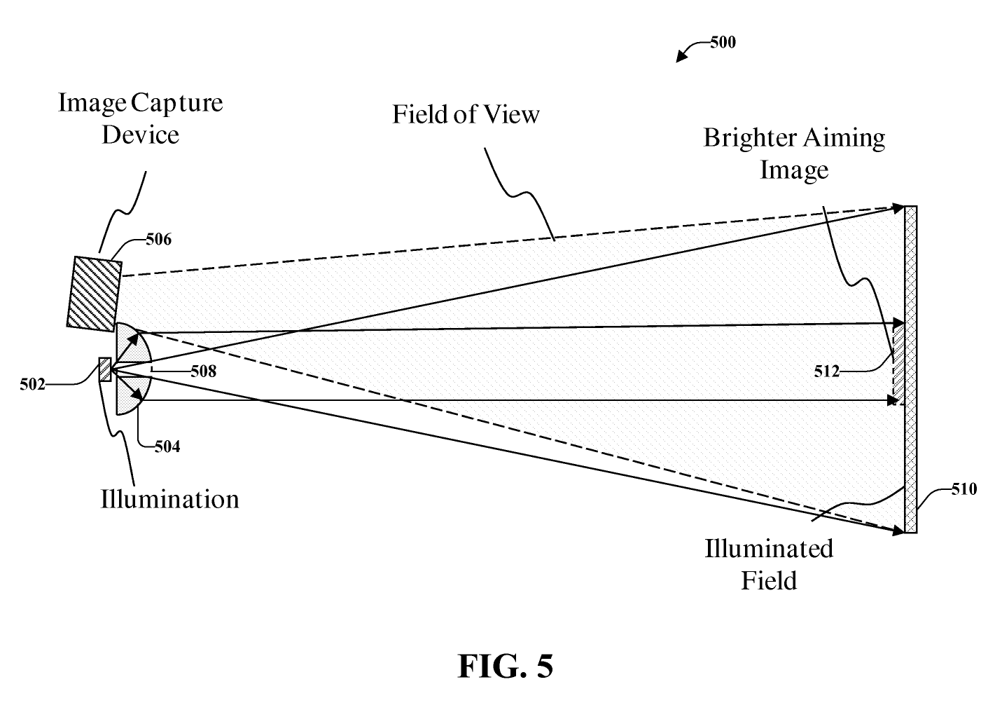

Referring now to FIG. 5, an exemplary embodiment of an imager 500 is shown in accordance with an embodiment of the present invention. The imager 500 includes a source 502, a collimating optical element 504, and an image capture device 506 (e.g. imager). The source 502 emits electromagnetic energy, wherein the electromagnetic energy is in the visible light spectrum. The source 502 can include but is not limited to light emitting diodes (L.E.D), incandescent light bulbs, halogen light bulbs, fluorescent light bulbs, mercury bulbs, metal halide bulbs, low-pressure sodium lamps, laser, etc.

Typically, the light emitted from the source 502 propagates along at least a semi-radial path (as previously discussed). The collimating optical element 504 is situated a predetermined distance from the source 502, and redirects at least a first portion of the light emitted from the source 502. The collimating optical element 504 can be comprised of one or more refractive lenses, one or more reflective elements (e.g. mirrors), or one or more interference elements, as well as a combination of the foregoing. In this example, the collimating optical element 504 includes an aperture 508 that allows a second portion of the light emitted from the source 502 to pass through the collimating optical element 504 undisturbed along its original propagation path forming an illumination field 510. The first portion of light redirected by the collimating optical element 504 generates a brighter aiming image 512 within the illumination field 510.

The brighter aiming image 512 provides for intuitive aiming of the imager 500 by simply observing the increased concentration of illumination against a subject image. Additionally, the brighter aiming image 512 provides increased illumination for image capture by the image capture device 506. The image capture device 506 captures images via systems and methods that are well known in the art. It is also well known that increased illumination can facilitate accurately capturing images by devices such as imagers, camcorders, and so forth. For instance, image-capturing devices typically produce representations that are more accurate when the subject is captured under better lighting conditions. Additionally, the image capture device 506 can be located adjacent to the source 502 and collimating optical element 504, wherein the collimating optical element 504 does not interfere with the viewing field of the image capture device 506.

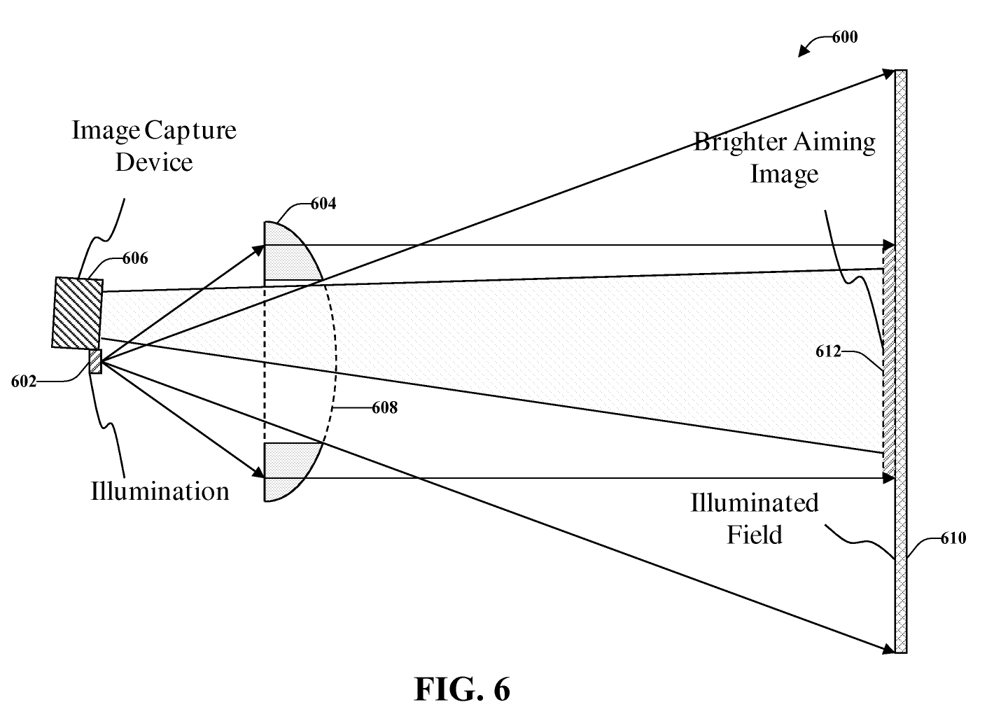

Referring now to FIG. 6, an alternative embodiment of an imager 600 is shown in accordance with the present invention. The imager 600 includes a source 602, a collimating optical element 604, and an image capture device 606 (e.g. imager). As noted supra, the source 602 emits electromagnetic energy, wherein the electromagnetic energy is in the visible light spectrum. The collimating optical element 604 is situated a distance from the source 602, and redirects at least a first portion of the light emitted. In this example, the collimating optical element 604 includes an aperture 608, which allows a second portion of the light emitted from the source 602 to pass through the collimating optical element 604 undisturbed along its original propagation path forming an illumination field 610.

The first portion of light redirected by the collimating optical element 604 generates a brighter aiming image 612 within the illumination field 610. The brighter aiming image 612 provides for instinctive/perceptive aiming of the imager 600. Additionally, the brighter aiming image 612 provides increased illumination for image capture by the image capture device 606. The image capture device 606 can be located in a plurality of configurations with respect to the source 602. For instance, the image capture device 606 can be parallel to the source 602, wherein the aperture 604 provides for an uninterrupted line of sight for the image capture device 606.

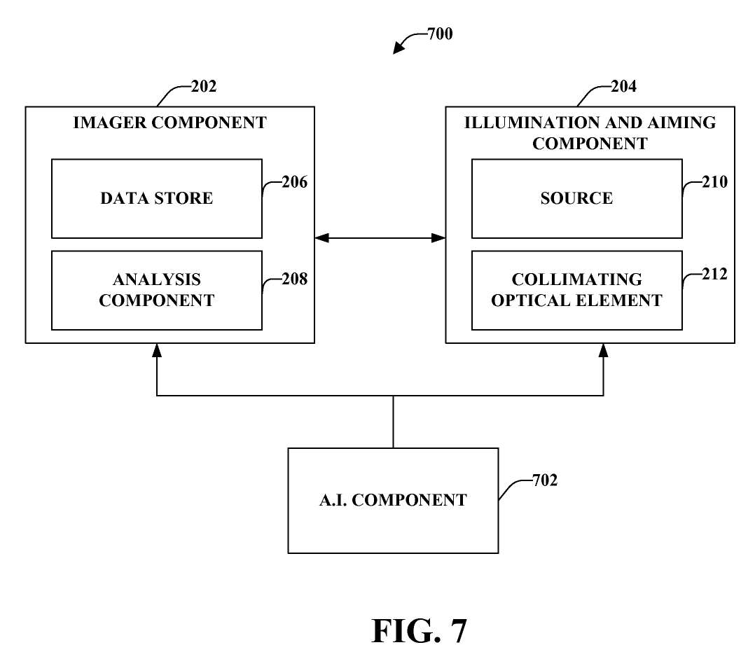

FIG. 7 illustrates a system 700 that employs an artificial intelligence (AI) component 702 that facilitates automating one or more features in accordance with the subject invention. The subject invention (e.g., in connection with inferring) can employ various AI-based schemes for carrying out various aspects thereof. For example, a process for dynamically adjusting the imaging system 700 can be facilitated via an automatic classifier system and process.

A classifier is a function that maps an input attribute vector, x=(x1, x2, x3, x7, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed (e.g., financial versus non-financial, personal versus non-personal, . . . ), and at what time of day to implement tighter criteria controls (e.g., in the evening when system performance would be less impacted).

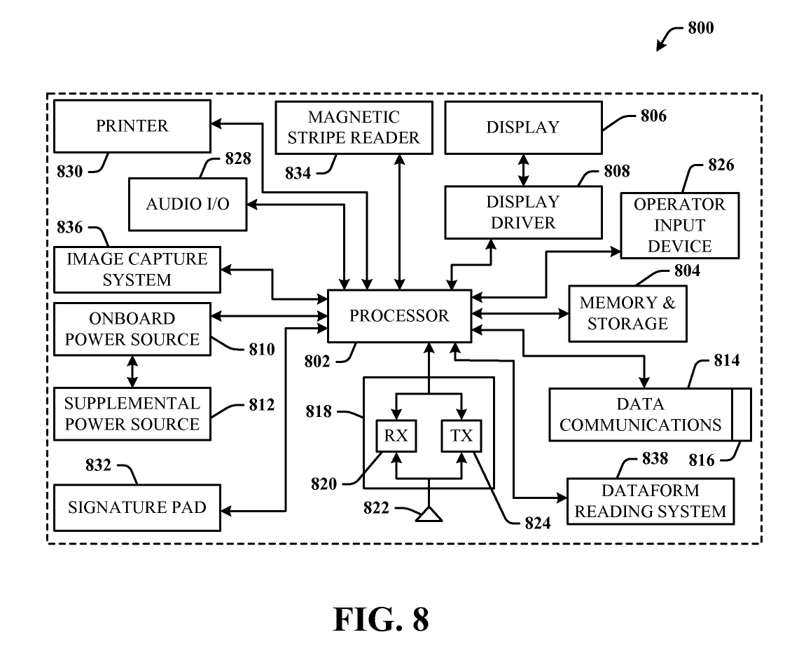

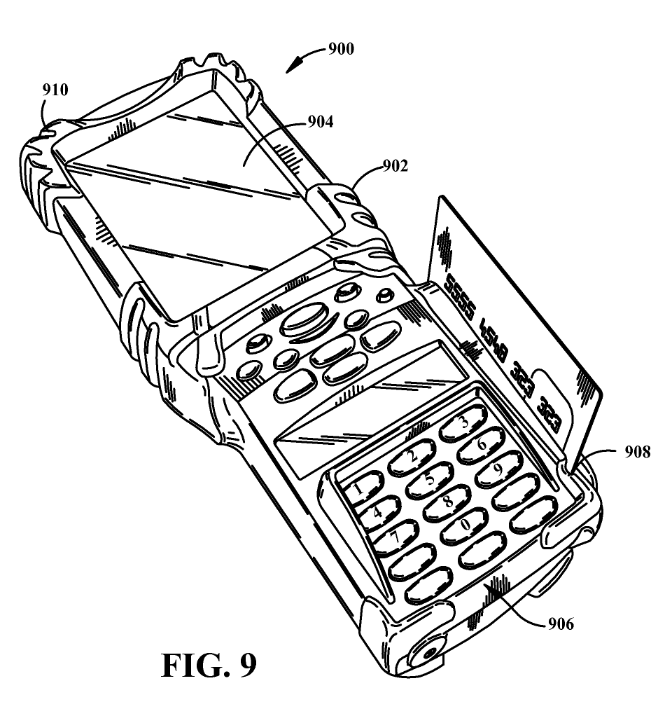

Referring now to FIG. 8, illustrated is a schematic block diagram of a portable hand-held terminal device 800 (similar to the portable scanning device 900 as illustrated in FIG. 9) according to one aspect of the invention, in which a processor 802 is responsible for controlling the general operation of the device 800. The processor 802 is programmed to control and operate the various components within the device 800 in order to carry out the various functions described herein. The processor 802 can be any of a plurality of suitable processors. The manner in which the processor 802 can be programmed to carry out the functions relating to the invention will be readily apparent to those having ordinary skill in the art based on the description provided herein.

A memory 804 connected to the processor 802 serves to store program code executed by the processor 802, and serves as a storage means for storing information such as user credential and receipt transaction information and the like. The memory 804 can be a nonvolatile memory suitably adapted to store at least a complete set of the information that is displayed. Thus, the memory 804 can include a RAM or flash memory for high-speed access by the processor 802 and/or a mass storage memory, e.g., a micro drive capable of storing gigabytes of data that comprises text, images, audio, and video content. According to one aspect, the memory 804 has sufficient storage capacity to store multiple sets of information, and the processor 802 could include a program for alternating or cycling between various sets of display information.

A display 806 is coupled to the processor 802 via a display driver system 808. The display 806 can be a color liquid crystal display (LCD), plasma display, or the like. In this example, the display 806 is a ¼ VGA display with sixteen levels of gray scale. The display 806 functions to present data, graphics, or other information content. For example, the display 806 can display a set of customer information, which is displayed to the operator and can be transmitted over a system backbone (not shown). Additionally, the display 806 can display a variety of functions that control the execution of the device 800. The display 806 is capable of displaying both alphanumeric and graphical characters.

Power is provided to the processor 802 and other components forming the hand-held device 800 by an onboard power system 810 (e.g., a battery pack). In the event that the power system 810 fails or becomes disconnected from the device 800, a supplemental power source 812 can be employed to provide power to the processor 802 and to charge the onboard power system 810. The processor 802 of the device 800 induces a sleep mode to reduce the current draw upon detection of an anticipated power failure.

The terminal 800 includes a communication subsystem 814 that includes a data communication port 816, which is employed to interface the processor 802 with a remote computer. The port 816 can include at least one of Universal Serial Bus (USB) and IEEE 1394 serial communications capabilities. Other technologies can also be included, for example, infrared communication utilizing an infrared data port.

The device 800 can also include a radio frequency (RF) transceiver section 818 in operative communication with the processor 802. The RF section 818 includes an RF receiver 820, which receives RF signals from a remote device via an antenna 822 and demodulates the signal to obtain digital information modulated therein. The RF section 818 also includes an RF transmitter 824 for transmitting information to a remote device, for example, in response to manual user input via a user input device 826 (e.g., a keypad) or automatically in response to the completion of a transaction or other predetermined and programmed criteria. The transceiver section 818 facilitates communication with a transponder system, for example, either passive or active, that is in use with product or item RF tags. The processor 802 signals (or pulses) the remote transponder system via the transceiver 818, and detects the return signal in order to read the contents of the tag memory. In one implementation, the RF section 818 further facilitates telephone communications using the device 800. In furtherance thereof, an audio I/O section 828 is provided as controlled by the processor 802 to process voice input from a microphone (or similar audio input device) and audio output signals (from a speaker or similar audio output device).

In another implementation, the device 800 can provide voice recognition capabilities such that when the device 800 is used simply as a voice recorder, the processor 802 can facilitate high-speed conversion of the voice signals into text content for local editing and review, and/or later download to a remote system, such as a computer word processor. Similarly, the converted voice signals can be used to control the device 800 instead of using manual entry via the keypad 826.

Onboard peripheral devices, such as a printer 830, signature pad 832, and a magnetic strip reader 834 can also be provided within the housing of the device 800 or accommodated externally through one or more of the external port interfaces 816.

The device 800 can also include an image capture system 836 such that the user can record images and/or short movies for storage by the device 800 and presentation by the display 806. Additionally, a dataform reading system 838 is included for scanning dataforms. It is to be appreciated that these imaging systems (836 and 838) can be a single system capable of performing both functions.

FIG. 9 is provided to assist in understanding and to provide context to an embodiment of the invention. Specifically, FIG. 9 illustrates an example of a handheld terminal 900 operative to execute the systems and/or methods disclosed herein. It is to be understood that the handheld terminal shown and described is merely exemplary and other devices can be utilized in accordance with the subject disclosure.

The handheld terminal 900 can include a housing 902, which can be constructed from a high strength plastic, metal, or any other suitable material. The handheld terminal 900 can also include a display 904. As is conventional, the display 904 functions to display data or other information relating to ordinary operation of the handheld terminal 900 and/or mobile companion (not shown). For example, software operating on the handheld terminal 900 and/or mobile companion can provide for the display of various information requested by the user.

Additionally, the display 904 can display a variety of functions that are executable by the handheld terminal 900 and/or one or more mobile companions. The display 904 can provide for graphics based alphanumerical information such as, for example, the price of an item requested by the user. The display 904 can also provide for the display of graphics such as icons representative of particular menu items, for example. The display 904 can also be a touch screen, which can employ capacitive, resistive touch, infrared, surface acoustic wave, or grounded acoustic wave technology.

The handheld terminal 900 can further include user input keys 906 for allowing a user to input information and/or operational commands. The user input keys 906 can include a full alphanumeric keypad, function keys, enter keys, etc. The handheld terminal 900 can also include a magnetic strip reader 908 or other data capture mechanism (not shown). An electronic signature apparatus can also be employed in connection with the magnetic strip reader or a telecheck system.

The handheld terminal 900 can also include a window 910 in which a bar code reader/bar coding imager is able to read a bar code label, or the like, presented to the handheld terminal 900. The handheld terminal 900 can include a light emitting diode (LED) (not shown) that is illuminated to reflect whether the bar code has been properly or improperly read. Alternatively, or additionally, a sound can be emitted from a speaker (not shown) to alert the user that the bar code has been successfully imaged and decoded. The handheld terminal 900 can also include an antenna (not shown) for wireless communication with a radio frequency (RF) access point; and an infrared (IR) transceiver (not shown) for communication with an IR access point.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

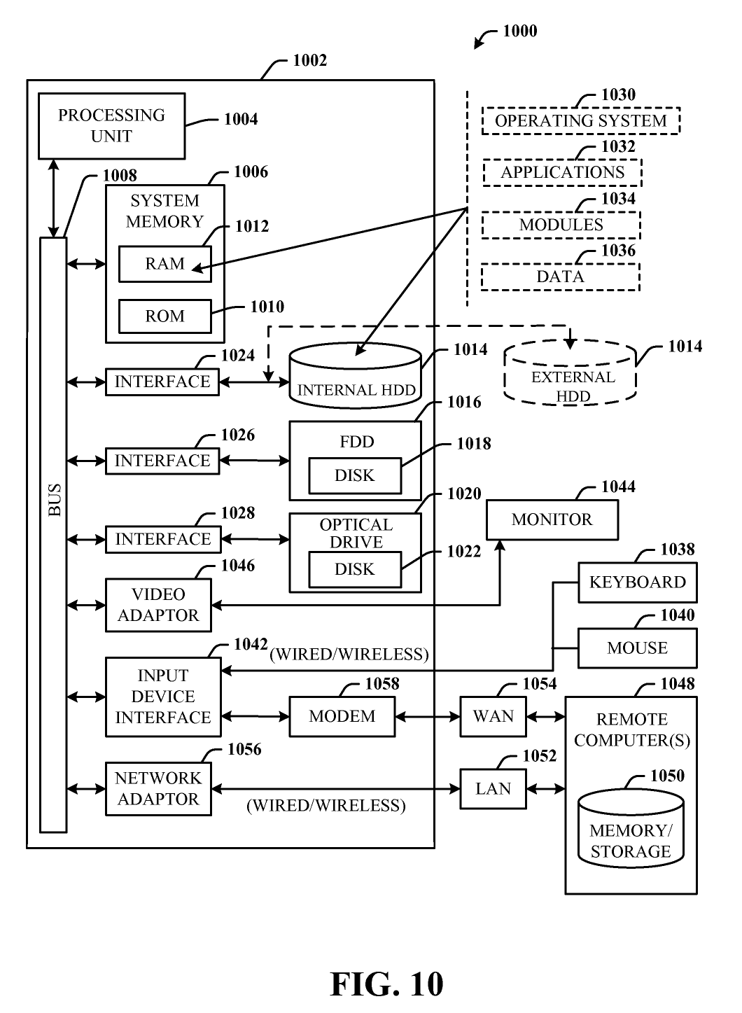

With reference again to FIG. 10, there is illustrated an exemplary environment 1000 for implementing various aspects of the invention that includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An imaging system for imaging a target barcode, comprising:
an imager component that captures at least one image;
an illumination and aiming component that provides users with a mechanism for intuitive aiming of the imaging system and illumination to facilitate image capture by the imager component, the illumination and aiming component including at least one source emitting visible light and a collimating optical element;
wherein the collimating optical element collimates at least a portion of the light emitted by the source to project an illumination light on the target barcode to form an illumination field, and the collimating optical element includes at least one aperture for projecting an aiming image in the midst of the illumination field that is brighter than the rest of the illumination field.

2. (canceled)

3. The system of claim 1, the source includes at least one of a light emitting diode (L.E.D), an incandescent light bulb, a halogen light bulb, a fluorescent light bulb, a mercury bulb, a metal halide bulb, a low-pressure sodium lamp, or a laser.

4. (canceled)

5. The system of claim 4, the collimating optical element is a refractive lens containing at least one aperture.

6. The system of claim 4, the collimating optical element is at least one reflective mirror.

7. The system of claim 4, the collimating optical element is at least one interference element.

8. The system of claim 1, the imager component includes a data store, wherein captured images can be stored on the data store.

9. The system of claim 1, the imager component includes an analysis component that analyzes the captured images to at least one of identify, locate, or decode data contained in the images.

10. The system of claim 9, the data includes at least one of: a bar code, or a data matrix.

11. The system of claim 1, wherein the illumination and aiming component can be dynamically adjusted to achieve at least one of illumination intensities, or focal region dimensions.

12. The system of claim 1, further comprising an artificial intelligence component that facilitates automating one or more features of the system.

13. An imaging system for imaging a target barcode, comprising:
an imager component that captures at least one image;
an illumination and aiming component that includes a source and a collimating optical element, the source emits visible light, and the collimating optical element facilitates projecting an illumination light on the target barcode to form an illumination field; and
wherein the collimating optical element is a refractive lens containing at least one aperture for projecting an aiming image in the midst of the illumination field that is brighter than the rest of the illumination field, wherein the refractive lens redirects light emitted from the source, and the aperture allows light to traverse the lens uninterrupted.

14. (canceled)

15. The system of claim 13, wherein the imager component includes an analysis component that analyzes the captured images to at least one of identify, locate, or decode at least one of a bar code, or a data matrix.

16. An imaging system for imaging a target barcode, comprising:
an imager that captures at least one image, and analyzes the captured images to at least one of identify, locate, or decode at least one of a bar code, or a data matrix; and
an illumination and aiming component that includes a source and optical collimating element, the source is at least one light emitting diode (L.E.D) that emits visible light, and the optical collimating element is a is a refractive lens containing at least one aperture, wherein the lens collimates a first portion of the visible light to project an illumination light on the target barcode to form an illumination field, and the aperture allows a second portion of the light to traverse the lens uninterrupted for projecting an aiming image in the midst of the illumination field that is brighter than the rest of the illumination field.

17. (canceled)

18. (canceled)

19. (canceled)

20. (canceled)
